(19) United States
(12) Patent Application Publication
(10) Pub. No.: US 2017/0199850 A1
(43) Pub. Date: Jul. 13, 2017

(54) METHOD AND SYSTEM TO DECREASE PAGE LOAD TIME BY LEVERAGING NETWORK LATENCY

(71) Applicant: SAMSUNG ELECTRONICS CO., LTD., Suwon-si (KR)

(72) Inventors: Vinod Kumar MISHRA, Noida (IN); Purnima SINGHAL, Noida (IN); Shiva KUMAR, Noida (IN)

(73) Assignee: SAMSUNG ELECTRONICS CO., LTD., Suwon-si (KR)

(21) Appl. No.: 15/404,787

(22) Filed: Jan. 12, 2017

(30) Foreign Application Priority Data
Jan. 13, 2016 (IN) 201611001279

(51) Int. Cl. G06F 17/22; H04L 29/06; H04L 29/08

(52) U.S. Cl. CPC G06F 17/2235; H04L 67/02; H04L 67/42; G06F 17/2247

(57) ABSTRACT

A method and an electronic device for displaying a webpage are provided. The method includes receiving, via a web browser, a request to open the webpage corresponding to a main web Uniform Resource Locator (URL), retrieving sub resource information that is pre-stored at a local location that is mapped to a parameter of the requested webpage, and requesting for sub resource content, based on the retrieved sub resource information. The method further includes receiving the requested sub resource content, and displaying the web page on the web browser, based on the received sub resource content and a main resource content.

### CROSS-REFERENCE TO RELATED APPLICATION

This application claims priority from Indian Patent Application No. 201611001279, filed on Jan. 13, 2016, in the India Patent Office, the disclosure of which is incorporated herein by reference in its entirety.

### BACKGROUND

1. Field

Methods and apparatuses consistent with exemplary embodiments relate to web browsing, and in particular, methods and electronic devices to decrease webpage load time by leveraging network latency.

2. Description of the Related Art

On the Internet, information used by a user is accessed by opening a webpage uniform resource locator (URL) or by opening links/hyperlinks present in webpages or search results obtained through the search engines. User can access any URL by typing the URL in the URL bar on a web browser or by clicking a hyperlink present inside a web page. A typical web application operates via Internet, intranet or any other computer network that includes multiple interconnected devices located on network nodes (nodes), and has at least one server and client. The server serves the web page information in response to a client request that is made for example by typing the URL in the URL bar on a web browser, and the client presents the information on a web browser. The client is responsible for parsing the response received from server and displaying it to the end user.

Generally, a request for a webpage URL returns a response that contains the main resource information that further contains the main resource and other sub-resource data that are indeed used to display the complete web page. For loading a complete webpage, its main resource content (index.html) as well as sub-resources (such as css, js/scripts, ttf, images, etc.) are to be fetched from the network.

Referring to FIG. 1, a request-response flow 100 in accordance with a prior art solution is illustrated. The process starts (at block 102 ) by requesting for a webpage URL. Once the request is made for a webpage URL, an initial request is made for the main resource content corresponding to the requested webpage URL as indicated in block 104. Thereafter, the electronic device checks whether the main resource content is received or not (block 106).

If the main resource content is not yet received, the electronic device waits for the receipt of the main resource content for a predetermined time as indicated in block 108, and if the main resource content is not received within the predetermined time period (block 110 ), the information flow process ends as indicated in block 112. On the other hand, if the main resource content is admitted/fetched at the client side (web browser or web based application) before the expiry of the predetermined wait period, processing starts at the client side. The fetched main resource content is parsed at the client end to process the data for display to user as per the predefined rules (block 118 and 120) and to identify additional sub-resource information/URL to request them from the server (block 114 and 116). The existing solutions also allow for processing in parallel, i.e., as soon as the resource content is received from the server in block 106, it can be sent further for processing and display (block 118 and 120) without waiting for other resources (provided it not blocked by any non-deferrable resource) and parallel processing can be done to identify (block 114) additional resources. Thus, it may be noticed that the sub-resources on which the display of main web page depends are not requested until the main resource content is received and processed to identify these sub resources. And, the client sits idle during the request-response process for the main resource content. A wait period (while waiting for the main resource content and parsing it to identify sub resource information) is involved in identifying the sub resources and receiving the sub resource content. This leads to latency in loading of the complete web page and ultimately affects and deteriorates the user experience.

Several solutions have been proposed to improve the loading time of a web page. In one of the solutions as disclosed in U.S. Patent Application Publication No. 2011/0066676 to Kleyzit et. al., titled “Method and system for reducing web page download time,” the web page response/loading time is improved by requesting multiple resources in a batch request, receiving the resources in a batch response, and disjoining the resources and corresponding HTTP headers before caching on the client. The client sends a batch request containing the web addresses of the multiple resources referenced by the base page, and the server is separately processing individual requests to web addresses. But, in the current case also, the client cannot send the batch request before receiving the main resource content. Hence, the waiting time still exists in this process.

In another solution as disclosed in publication titled at “How the Browser Pre-loader Makes Pages Load Faster” available at “http://andydavies.me/blog/2013/10/22/how-the-browser-pre-loader-makes-pages-load-faster/,” a light-weight parser along with the main parser is proposed to identify and request the sub resources early, so that at any instant of time the blockage in processing of the main content of web page due to the absence of the non-deferrable resources can be minimized. Though it allows significant improvement in the performance of browser, the request for these sub resources is not sent until the main resource document has not been downloaded from the server end.

Thus, there exists a need to overcome the problems in the existing solutions and provide a mechanism to combat the latencies arising due to networking and loading of resources from the server end. In particular, a need exists to provide an improved solution to decrease the loading latency of a webpage and improve the viewing experience of the user.

### SUMMARY

Exemplary embodiments may address at least the above problems and/or disadvantages and other disadvantages not described above. Also, the exemplary embodiments are not required to overcome the disadvantages described above, and may not overcome any of the problems described above.

According to an aspect of an exemplary embodiment, there is provided a method of displaying a webpage, the method includes receiving, via a web browser, a request to open the webpage corresponding to a main web Uniform Resource Locator (URL), retrieving sub resource information that is pre-stored at a local location that is mapped to a parameter of the requested webpage, and requesting for sub resource content, based on the retrieved sub resource information. The method further includes receiving the requested sub resource content, and displaying the web page on the web browser, based on the received sub resource content and a main resource content.

The method may further include receiving the main resource content, detecting additional sub resource information in the received main resource content, and requesting for additional sub resource content, based on the detected additional sub resource information.

The method may further include extracting the additional sub resource information from the received main resource content.

The method may further include receiving the requested additional sub resource content, and displaying the web page on the web browser, based on the received main resource content, the received sub resource content, and the received additional sub resource content.

The method may further include requesting for the main resource content, and receiving the requested main resource content.

The requesting for the main resource content and the requesting for the sub resource content may be performed simultaneously, or the requesting for the main resource content may be performed subsequent to the requesting for the sub resource content, or the requesting for the main resource content may be performed prior to the requesting for the sub resource content.

The retrieving of the sub resource information may be based on any one or any combination of a priority value of the sub resource information, a time of load information, a level of independency of the sub resource information, and a type of the sub resource content corresponding to the sub resource information.

The method may further include storing the sub resource information at the local location.

The method may further include accessing the main web URL prior to the receiving of the request to open the webpage, and generating and storing the sub resource information at the local location.

The generating and storing of the sub resource information may include retrieving, from a server, the main resource content corresponding to the main web URL, parsing the retrieved main source content to identify one or more sub-resources, and generating and storing model data, based on the identified one or more sub-resources.

The method may further include receiving the main resource content, processing the received main resource content to extract sub resource information from the received main resource content, analyzing the extracted sub resource information with the pre-stored sub resource information, and updating the pre-stored sub resource information, based on the analyzing.

The updating may include any one or any combination of a modification, an insertion, or a deletion that is made to a part of the pre-stored sub resource information.

The method may further include updating the pre-stored sub resource information, based on any one or any combination of a priority value of the pre-stored sub resource information, a time of load information, and meta data of a sub resource.

The sub resource information may include information of one or more sub resources including any one or any combination of images, video files, audio files, scripts, style sheets web fonts, and a sub resource to be used for displaying or rendering the sub resource or another sub resource.

The request to open the webpage may include an individual request for an URL, or a list of one or more URLs that are requested together, or a list of one or more URLs that are requested in a batch mode.

According to an aspect of an exemplary embodiment, there is provided a method of displaying a webpage, the method including receiving, via a web browser, a request to open the webpage corresponding to a main web Uniform Resource Locator (URL), retrieving a sub resource information that is pre-stored at a local location that is mapped to a parameter of the requested webpage, and requesting for sub resource content, based on the retrieved sub resource information. The method further includes receiving main resource content and the requested sub resource content, determining whether additional sub resource information is in the received main resource content, displaying the web page on the web browser, based on the received main resource content, the received sub resource content, and the additional sub resource content, in response to the determining that the additional sub resource content is in the received main resource content, and displaying the web page on the web browser, based on the received main resource content and the received sub resource content, in response to the determining that the additional sub resource content is not in the received main resource content.

The method may further include extracting sub resource information from the received main resource content, and comparing the extracted sub resource information with the pre-stored sub resource information.

The method may further include storing the sub resource information and the additional sub resource information at the local location.

According to an aspect of another exemplary embodiment, there is provided an electronic device for displaying a webpage, the electronic device including a first receiver configured to receive, via a web browser, a request to open the webpage corresponding to a main web Uniform Resource Locator (URL), and a retriever configured to retrieve sub resource information that is pre-stored at a local location that is mapped to a parameter of the requested webpage, and request for sub resource content, based on the retrieved sub resource information. The electronic device further includes a second receiver configured to receive the requested sub resource content, and a display configured to display the web page on the web browser, based on the received sub resource content and a main resource content.

According to an aspect of another exemplary embodiment, there is provided a electronic device for displaying a webpage, the electronic device including a receiver configured to receive, via a web browser, a request to open the webpage corresponding to a main web Uniform Resource Locator (URL), and a retriever configured to retrieve a sub resource information that is pre-stored at a local location that is mapped to a parameter of the requested webpage, and request for sub resource content, based on the retrieved sub resource information. The receiver is further configured to receive main resource content and the requested sub resource content. The electronic device further includes a processor configured to determine whether additional sub resource information is in the received main resource content, and a display configured to display the web page on the web browser, based on the received main resource content, the received sub resource content, and the additional sub resource content, in response to the determining that the additional sub resource content is in the received main resource content, and display the web page on the web browser, based on the received main resource content and the received sub resource content, in in response to the determining that the additional sub resource content is not in the received main resource content.

### BRIEF DESCRIPTION OF THE DRAWINGS

The above and/or other aspects will be more apparent by describing exemplary embodiments with reference to the accompanying drawings, in which:

FIG. 1 is a flowchart illustrating a method of a request-response flow;

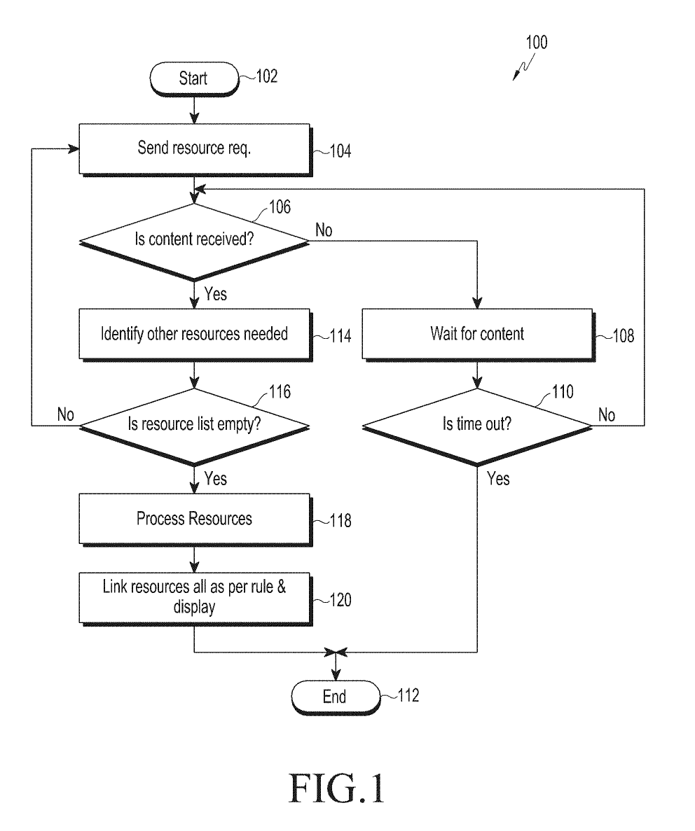

FIG. 2 is a flowchart illustrating a method of displaying a webpage, according to an exemplary embodiment;

FIG. 3 is a flowchart illustrating a method of displaying a webpage, according to another exemplary embodiment;

FIG. 4 is a block diagram of a electronic device for displaying a webpage, according to an exemplary embodiment;

FIG. 5 is a block diagram of a system for displaying a webpage, according to another exemplary embodiment;

FIG. 6 is a flowchart illustrating an information process implemented by the system as illustrated in FIG. 5, according to an exemplary embodiment;

FIG. 7 is a flowchart illustrating a method of displaying a webpage, according to another exemplary embodiment;

FIG. 8 is a block diagram of a electronic device for displaying a webpage, according to another exemplary embodiment;

FIG. 9 shows a webpage according to an exemplary embodiment;

FIG. 10 shows another webpage indicating sub resources associated with a web url, according to an exemplary embodiment;

FIG. 11 is a diagram illustrating a flow of loading a webpage without using trained data;

FIG. 12 is a diagram illustrating a flow of loading a webpage using trained data, according to an exemplary embodiment;

FIG. 13 is a timing diagram of loading of an internet content service website, using a web inspector;

FIG. 14 is a timing diagram of loading of an internet content service website, using a web inspector according to an exemplary embodiment; and

FIG. 15 is a diagram illustrating a hardware configuration of a computer system representative of a hardware environment, according to an exemplary embodiment.

### DETAILED DESCRIPTION

Exemplary embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the exemplary embodiments. However, it is apparent that the exemplary embodiments can be practiced without those specifically defined matters. Also, well-known functions or constructions are not described in detail because they would obscure the description with unnecessary detail.

In addition, the terms such as “unit,” “-er (-or),” and “module” described in the specification refer to an element for performing at least one function or operation, and may be implemented in hardware, software, or the combination of hardware and software.

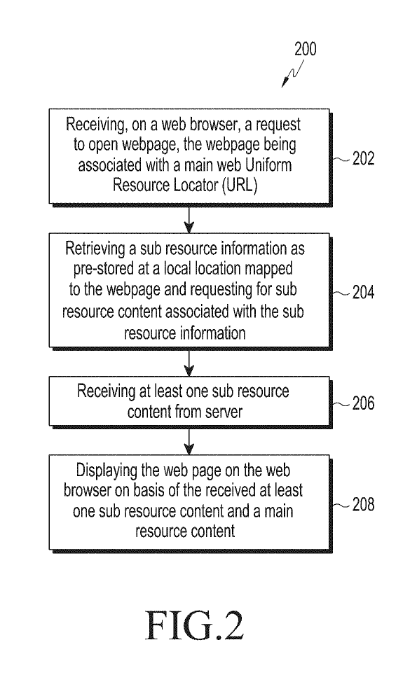

FIG. 2 is a flowchart illustrating a method 200 of displaying a webpage, according to an exemplary embodiment. The method 200 includes step 202 for receiving, on a web browser, a request to open the webpage, the webpage being associated with a main web Uniform Resource Locator (URL). The request to open the webpage may be of the form including, but not limited to, any one or any combination of a URL entered at the URL bar of the web browser, a link/hyperlink present in a webpage or redirected links/hyperlinks, etc. The request to open the webpage may include Individual request for URL or a List of one or more URLs requested together or a List of one or more URLs requested in a batch mode.

Once the request to open the webpage is received in step 202, a sub resource information as pre-stored at a local location in a mapped relationship with a parameter pertaining to the webpage is retrieved, and sub resource content associated with the sub resource information is requested in step 204. The parameter pertaining to the webpage may include main resource URL, main resource content or any information that is associated with the requested main web page. The sub resource information is generated and stored at the local location when the main web URL is accessed at an earlier time. In an exemplary embodiment, the sub resource information may be stored at a plurality of local locations in the user/client device. The sub resource information contains information in respect of various sub resources that are used to display the main content of a webpage.

A categorization of the sub-resources has been used here. Deferrable resources refer to the ones that can be loaded in an asynchronous mode (along with some other processing) or can be lazy-loaded (or in defer mode, i.e., loaded at some later stage without blocking the parser to wait for it to be fetched and executed), and allow the processing of main document without any blockage. Non-Deferrable resources cannot be lazy-loaded as these resources are used (for rendering) before further processing of the main document.

Once a webpage is visited by a user/client device for the first time, the information about its sub-resources is identified and processed. In other words, the sub resource information is generated using the information associated with the main web page like main web URL, metadata and the main resource content received. The generating and storing includes retrieving the main resource content associated with the main web URL from server. The retrieved main source content is parsed and processed to identify one or more sub resources and thereafter a model data is created and stored based on the identified one or more sub resources. This processed model data is referred to as sub resource information/TRAINED INFORMATION. The sub resource information as pre-stored at the local location may be interchangeably referred to as TRAINED INFORMATION in the description. In an exemplary embodiment, the trained information may also contain sub resource content corresponding to all or part of stored sub resource information.

In an exemplary embodiment, the sub resource/trained information includes information pertaining to one or more sub resources of the form including any one or any combination of: Images (png, jpeg, gif, svg, jpg, etc.), Video/animation files (mp4, gif, wmv, avi, fly, etc.); Audio files (mp3, way, aac, etc.); Scripts (js, swf etc); Style Sheets (css etc), Web fonts (ttf, opf, woff etc); and any other type of sub-resource used for the display/rendering of itself or another resource. A categorization of types of information that form part of the trained information is used here. This includes storage based information type that provides information relating to the name of the server and location of the sub resource content (web link/URL) from where the sub resource is to be fetched. A content based information type that includes details such as size of content, type of content (deferrable/non deferrable), name of content/title, Server Last Modified Time, Server Time, Expiry Time, Cache Control, Content Encoding, Server Response, etc. The trained information may also contain information pertaining to priority levels for fetching sub resources (gets updated based on learning) at client side or server side or both, user request header, user last accessed time, etc. The trained information is stored in textual form. Hence, the space used for information relating to each sub-resource is minimal, allowing plenty of storage to maintain the trained information and web page modeling system well.

The method 200 thereafter includes receiving at least one sub resource content from server at step 206 and displaying the web page on the web browser on basis of the received at least one sub resource content and a main resource content at step 208. In an exemplary embodiment, the method 200 includes requesting retrieval of the main resource content and in response thereto receiving the main resource content from the server. In an exemplary embodiment, the request for the retrieval of the main resource content and request for the retrieval of the sub resource content are made simultaneously. In another exemplary embodiment, the request for the retrieval of the main resource content is made subsequent to making the request for the retrieval of the sub resource content. In another exemplary embodiment, the request for the retrieval of the main resource content is made prior to making the request for the retrieval of the sub resource content. The retrieval of the sub resource content from server may be based on one or more predetermined criterion selected from a group including a priority value associated with the sub resource information, time of load information, a level of independency of the sub resource information and type of sub resource content associated with the sub resource information.

In a further exemplary embodiment, the method 200 further includes requesting for additional sub resource content, if additional sub resource information is detected in the received main resource content. The additional sub resource information can be identified after comparing the stored sub resource information (trained information) with the sub resource information as extracted from the received main resource content. The method 200 further includes extracting the additional sub resource information from the received main resource content, requesting additional sub resource content corresponding to the extracted additional sub resource information and in response thereto receiving the additional sub resource content. Thereafter, the web page is displayed on the web browser on basis of the received main resource content, sub resource content and at least one additional sub resource content.

In another exemplary embodiment, the method 200 further provides a mechanism to identify if any change is to be made to the pre-stored sub resource information. This includes processing the received main resource content to extract sub resource information contained in the received main resource content. Thereafter, the sub resource information as extracted from the received main resource content and sub resource information as pre-stored at the local location are analyzed and the sub resource information as pre-stored at the local location is updated based on the analysis. The updating may include modification, insertion or deletion made to at least one part of sub resource information as pre-stored at the local location. In case no change is identified based on the analysis, no alteration is made to the pre-stored sub resource information. The method 200 further includes updating the sub resource information as pre-stored at the local location based on one or more predetermined criterion selected from a group including, but not limited to, a priority value associated with a sub resource; time of load information; any meta data associated with the sub resource.

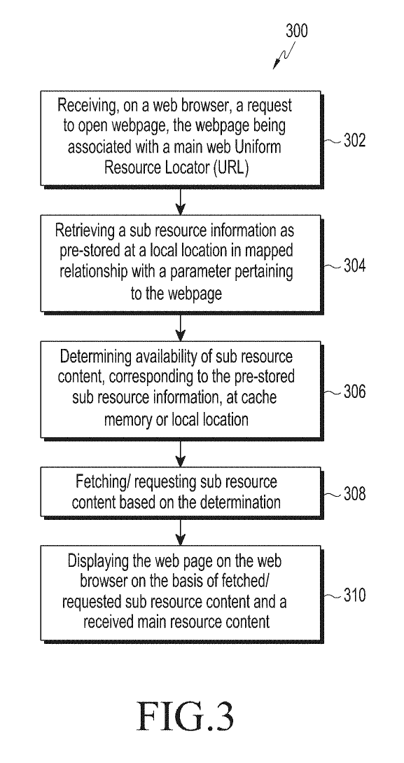

FIG. 3 is a flowchart illustrating a method 300 of displaying a webpage, according to another exemplary embodiment. The method 300 includes step 302 for receiving on a web browser a request to open the webpage, the webpage being associated with a main web Uniform Resource Locator (URL). Once the request to open the webpage is received at step 302, a sub resource information as pre-stored at a local location in mapped relationship with a parameter pertaining to the webpage is retrieved at step 304. Thereafter, the method involves determining (at step 306) availability of sub resource content, corresponding to the sub resource information as pre-stored at the local location, at cache memory or local location.

Based on the determining at step 306, the sub-resource content is fetched/requested at step 308. In case the sub resource content corresponding to the entire pre-stored sub resource information is found to be available at the cache memory or local location, the same is fetched from the cache memory or local location. Thereafter, the method 300 involves displaying (at step 310 ) the web page on the web browser on basis of the sub resource content as fetched/requested from the cache memory or local location and a received main resource content.

Thus, unlike an exemplary embodiment illustrated in FIG. 2, the sub resource content corresponding to the pre-stored sub resource information is fetched from the cache memory or local location and not from the server. The web page may be loaded more quickly as the delay in sending the request for sub resource content and receiving the same thereof from the server is removed as the sub resource content is fetched directly from cache memory or local location.

In an example, if at step 306, it is determined that only part of/partial amount of sub resource content corresponding to the sub resource information as pre-stored at the local location is available at the cache memory or local location, then the partial available sub resource content is fetched from the cache memory or local location and other non-available content is requested from the server. Thereafter, the web page is displayed (at step 308 ) on the web browser on basis of sub resource content as received from the server, sub resource content as fetched from cache memory or local location and a received main resource content. In case no sub resource content corresponding to the pre-stored sub resource information is found to be available at the cache memory or local location at step 306, the same is fetched from the server and the web page is displayed in the same manner as illustrated in FIG. 2.

In an exemplary embodiment, the method 300 involves detecting presence of an additional sub resource content in received main resource content. The detection of the presence of the additional sub resource information in the received main resource content involves extracting the sub resource information as contained in the received main resource content and comparing the sub resource information as extracted from the received main resource content with the sub resource information as pre-stored at the local location and sub resource information as derived from the sub resource content stored in the cache memory (if available). And, if presence of additional sub resource information is detected in the received main resource content, the additional sub resource content is requested from the server and is received thereupon. Thereafter, the method 300 includes displaying the web page on the web browser on basis of the received main resource content, sub resource content as fetched from the cache memory and/or server, and received additional sub resource content. However, if presence of additional sub resource information is not detected in the received main resource content, the web page is displayed on the web browser on the basis of the received main resource content and sub resource content as fetched from the cache memory and/or server.

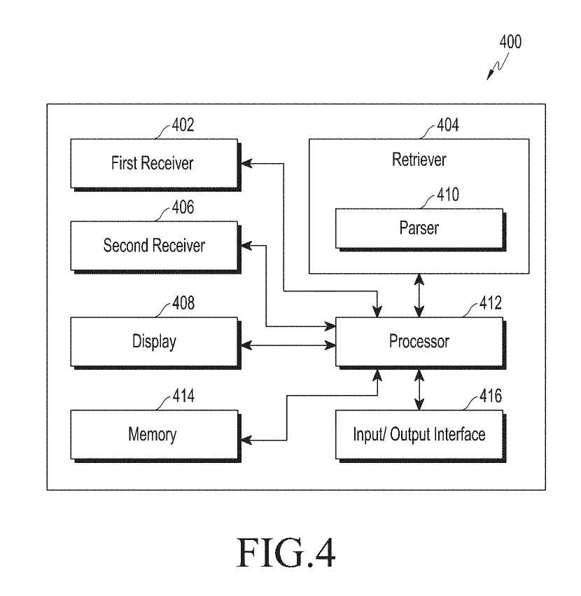

FIG. 4 is a block diagram of a electronic device 400 for displaying a webpage, according to an exemplary embodiment. The electronic device 400 includes a first receiver 402 for receiving, on a web browser, a request to open the webpage, the webpage being associated with a main web Uniform Resource Locator (URL). A retriever 404 is provided for retrieving a sub resource information as pre-stored at a local location in mapped relationship with a parameter pertaining to the webpage and requesting for sub resource content associated with the sub resource information. In an exemplary embodiment, the sub resource information may be stored at a plurality of local locations in the user/client device.

The electronic device 400 further includes a second receiver 406 for receiving at least one sub resource content from the server (or from cache memory or local location if available), and a display 408 for displaying the web page on the web browser on basis of the received at least one sub resource content and a main resource content. The retriever 404 further includes a parser 410 that in operational interconnection with a processor 412 is configured for detecting if additional sub resource information is detected in the received main resource content. And, if additional sub resource information is detected in the received main resource content, the processor 412 extracts the additional sub resource information from the received main resource content, and in operational interconnection with the display 408 displays the web page on the web browser on basis of the received main resource content, at sub resource content and at least one additional sub resource content. In an exemplary embodiment, the processor 412 may control operations other modules of the electronic device (i.e. the first receiver 402, the second receiver 406, the display 408, the memory 414, the retriever 404, and the input/output interface 416 ). Each of the modules of electronic device 400 may be implemented in hardware or software or combination of both.

The electronic device 400 further includes memory 414 for storing the trained information. An input/output interface 416 is further provided for receiving one or more inputs from the user, for instance for receiving request to open a webpage. Each of the aforesaid modules/units is operably interconnected to each other. In an exemplary embodiment, the retriever 404 and the processor 406 may form a standalone module. In an exemplary embodiment, the first receiver 402 and the second receiver 406 may form a standalone module.

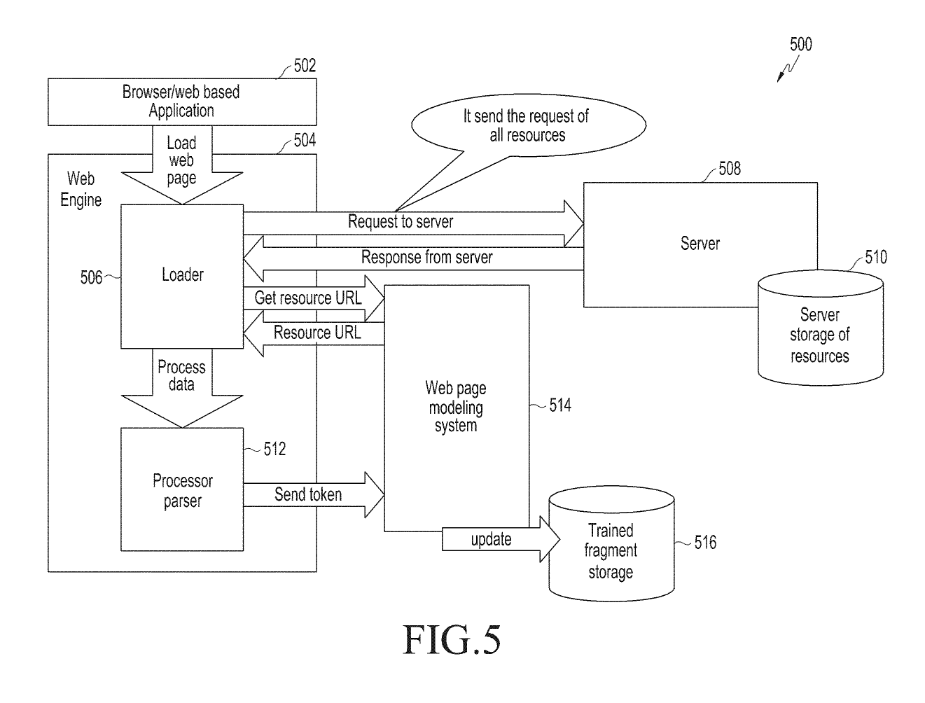

FIG. 5 is a block diagram of a system 500 for displaying a webpage, according to another exemplary embodiment. The system 500 includes a browser/web based application module 502 that is configured to receive a request for retrieval of a main webpage/resource URL. The system 500 further includes a web engine module 504 that in turn includes a loader module 506 configured to load the webpage corresponding to the main webpage/resource URL. The loader module 506 is configured to send requests for fetching main resource content and sub resource content to a server 508 and receiving the response thereto from the server 508. The server 508 includes a storage module 510 that stores the main resource content and the sub resource content. The web engine module 504 further includes a processor/parser 512 that is configured to analyze the response received from the server 508 and further interact with a web page modelling system 514. The processor 512 further includes a parser for parsing the web page and generating tokens thereof.

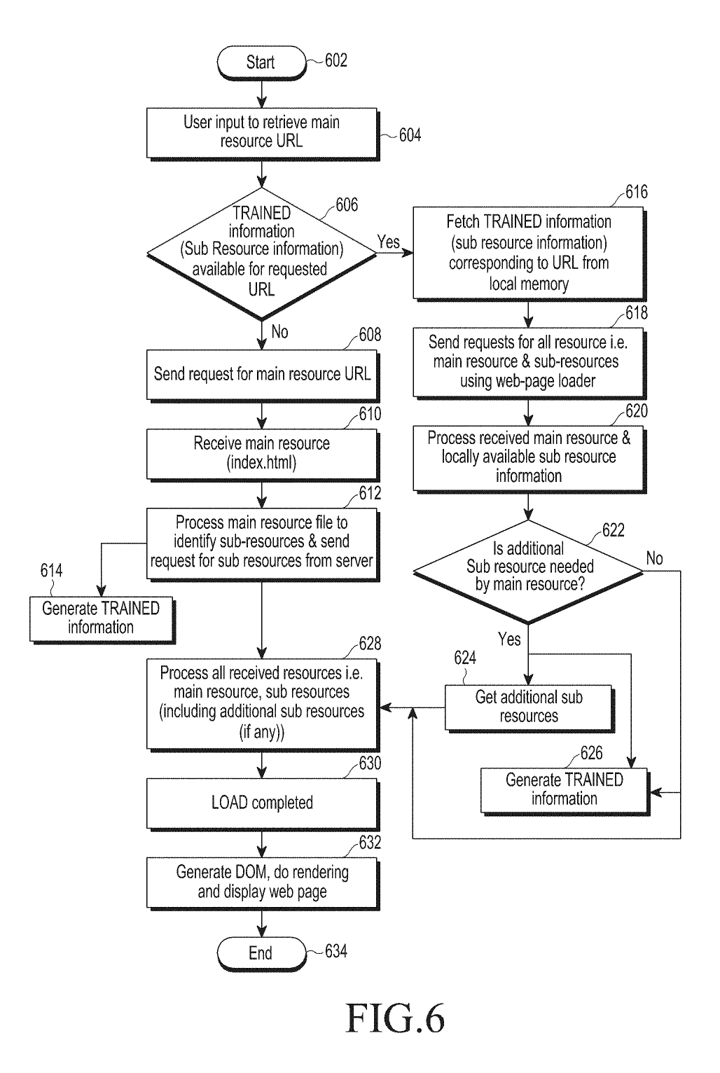

The web page modelling system 514 is provided for generating modelled data of the sub resources corresponding to the main resource URL. The web page modelling system 514 is configured to identify the details of the resources, for, e.g., on the basis of deferring and non-deferring nature of the resources and processing their details to create a modelled data. The processed information/modelled data of the sub resources, also referred to as the trained information, is stored in a trained fragment storage module 516. The trained fragment storage module 516 stores various details, in respect of the sub resources, including name of the server and location of the sub resource content (web link/URL) from where the sub resource are to be fetched; content based information type that includes details such as size of content, type of content (deferrable/non deferrable), name of content/title, Server Last Modified Time, Server Time, Expiry Time, Cache Control, Content Encoding, Server Response, etc.; information pertaining to priority levels for fetching sub resources at client side or server side or both, user request header, user last accessed time, etc. The web page modelling system 514 is further configured to update/modify the trained information stored in the trained fragment storage module 516. The detailed functioning and operation of the various modules of the system 500 shall be explained in light of following FIG. 6.

FIG. 6 is a flowchart illustrating an information process implemented by the system 500 as illustrated in FIG. 5, according to an exemplary embodiment. For the purposes of explanation of FIG. 6, the references used in FIG. 5 shall also be used. The process starts (at block 602 ) by receiving a user input for requesting retrieval of a main webpage/resource URL (at block 604 ) by the browser/application module 502. Once the user input is received, the web engine module 504 checks for the availability of the trained information stored in the trained fragment storage module 516 corresponding to the requested main resource URL as indicated in block 606. As discussed previously, when a webpage is visited by a user for the first time, the information about its sub-resources is identified and processed. This processed information about the sub-resources is referred to as sub resource information/trained information. The trained information is stored in the local memory of the client device, i.e., trained fragment storage module 516. On identifying that the trained information for the requested main resource URL is not available, i.e., the main resource URL is visited by the user/client for the first time, the loader module 506 does normal loading of the web page and the web page modelling system 514 does the modelling to generate trained information. In such a case, a request is made for the main resource URL to the server 508 as indicated in block 608. A request for main resource URL returns a response that contains the main resource content in form of HTML documents that includes an index.html file containing inline script and style (js, css, etc.), and various HTML tags representing view of the complete web page, etc. As indicated in block 610, the main resource content is received by the loader module 506 pursuant to sending the request for the main resource URL.

On receiving the main resource content, the main resource content is processed by the processor/parser 512 to identify the sub resource information that contains information in respect of various sub resources that are used to display the main content of a webpage (block 612 ). The information URL of various sub-resources used to display web page are identified. On identifying the information URL of various sub-resources, various requests are sent to the server 508 to load these sub-resources at the client side (block 612 ).

At the same time, the trained information may be generated (block 614 ) by the web page modelling system 514 and stored at the trained fragment storage 516 (local client device memory) that may be used when a request for the same main resource URL is made in future. The generation of the trained information, by the web page modelling system 514, involves processing of the received main resource content and identifying the sub resource information corresponding to the various sub resources that may be of the form including any one or any combination of: Images; Video files; Audio files; Scripts; css/style sheets, web font files, java scripts, or any other type of sub-resource used for the display/rendering of itself or another resource. The generation involves identifying and processing details about sub-resources, to create a modelled data. This processed information/modelled data about the sub-resources is referred to as the trained information and is stored in the local location in the client device for future purposes.

On the other hand, on identifying that the trained information is available for the requested main resource URL (in block 606 ), the loader 506 fetches the pre-stored trained information corresponding to the requested URL from trained fragment storage module 516 (block 616 ) and sends a request to the server 508 for loading or retrieval of the content of the sub resources identified in the trained information and also sends a request to the server 508 for retrieving the main resource content (block 618 ). Thus, as the information in respect of the sub resources is already available, there is no need to wait for the receipt of the main resource content from the server 508 for identifying the information relating to the sub resources. This leads to significant decrease in loading latency of the complete webpage. The request for the retrieval of the main resource content and request for the retrieval of the sub resource content may be made simultaneously; or the request for the retrieval of the main resource content may be made subsequent to making the request for the retrieval of the sub resource content; or the request for the retrieval of the main resource content is made prior to making the request for the retrieval of the sub resource content. Thereafter, once the main resource content is received, the main resource content and the stored sub resource information are processed by the processor 512 to detect presence of additional sub resource content in the received main resource content (block 620 ). At block 622, if presence of additional sub resource information is detected and found to be used in the received main resource content, requests are made to the server for loading or retrieval of the content of the additional sub resources identified in the additional sub resource information (block 624 ).

Further, if presence of additional sub resource information is detected, the sub resource information stored in the local memory, i.e., the stored trained information is updated by merging the additional sub resource information with the earlier stored trained information (block 626 ). In other words, an updated trained information is generated. In an exemplary embodiment, generating the updated trained information includes parsing, by parser, the received main resource content for extracting the sub resource information as contained in the received main resource content and comparing the sub resource information as extracted from the received main resource content with the stored sub resource information to identify changes in the existing stored sub resource information. The analysis of the received main resource content for identifying changes in the existing stored sub resource information ensures correctness of the sub resource information before proceeding further. Thereafter, the stored sub resource information is updated based on the comparison and analysis. The updating includes modification, insertion/addition or deletion made to at least one part of the stored sub resource information. In case, it is found that the sub resource information has partly changed, the non-existent sub resource information is removed and accordingly the stored trained information is updated based on the removal. In case, it is found that the sub resource information has completely changed, the stored trained information is updated after replacing the entire sub-resource information stored at the local location with the sub resource information as extracted from the received main resource content. In case, it is found that additional sub resource information is used, the additional sub resource information is merged with the existing stored trained information and accordingly the stored trained information is updated based on the merging. Updating/Modifying the stored information may include, but not limited to, updating/modifying the information such as Title of Main Resource page, Server Last Modified Time, Server Time, Expiry Time, Cache Control, Content Encoding, Server Response, details pertaining to last access by the user, etc. In an exemplary embodiment, the trained information may also be updated/modified based on the meta data of the sub-resources. The meta data may include, but not limited to, content size, blocking nature, time of used of resource, analysis of previous time to load, etc.

Once all the content, i.e., main resource content, sub-resource content (including additional sub resources, if any) is received, the entire chunk of content is processed (block 628 ) and their load is completed (block 630 ), a Document Object Model (DOM) is generated and the process of rendering and display of the complete webpage is initiated (block 632 ) and the process ends (block 634 ).

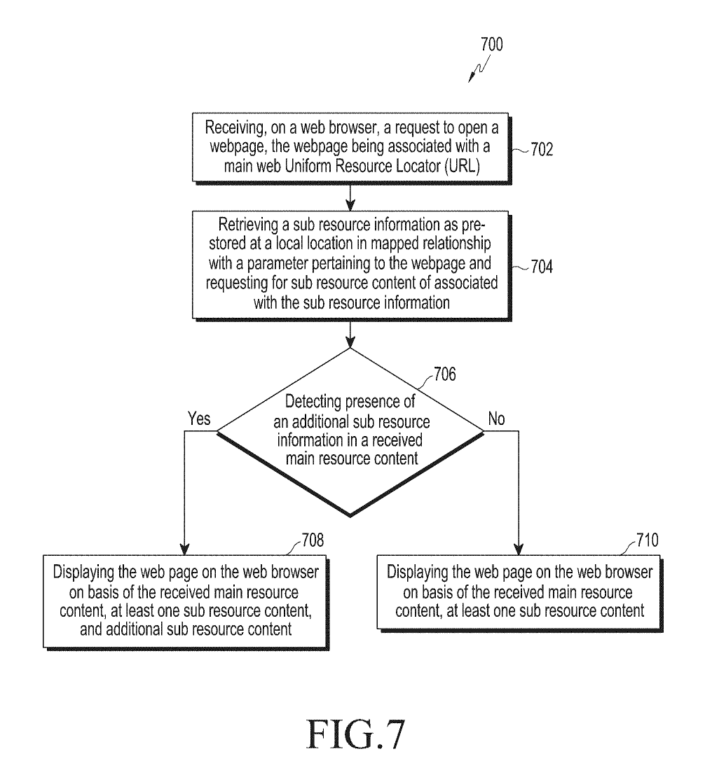

FIG. 7 is a flowchart illustrating a method 700 of displaying a webpage, according to another exemplary embodiment. The method 700 includes a step 702 for receiving, on a web browser, a request to open the webpage, the webpage being associated with a main web Uniform Resource Locator (URL). The method 700 further includes retrieving sub resource information as pre-stored at a local location in mapped relationship with a parameter pertaining to the webpage and requesting for sub resource content associated with the sub resource information as indicated in step 704. In an exemplary embodiment, the sub resource information may be stored at a plurality of local locations in the user/client device. The sub resource content may be requested from the server or may be fetched directly from the cache memory or local location if available. The parameter pertaining to the webpage may include main resource URL, main resource content or any information that is associated with the requested main web page.

Thereafter, the method 700 involves step 706 for detecting presence of an additional sub resource content in received main resource content. The step 706 of detecting presence of the additional sub resource information in the received main resource content involves extracting the sub resource information as contained in the received main resource content. Thereafter, the sub resource information as extracted from the received main resource content is compared with sub resource information as pre-stored at a local location.

And, if presence of additional sub resource information is detected in the received main resource content, the method 700 includes displaying, at step 708, the web page on the web browser on basis of the received main resource content, sub resource content, and at least one additional sub resource content. In an exemplary embodiment, if on comparing, it is found that the sub resource information as extracted from the received main resource content is completely different from the sub resource information as pre-stored at the local location, i.e., no part of the sub resource information as pre-stored at the local location would be relevant for the purposes of display of the web page, the content corresponding to complete sub resource information as extracted from the received main resource content is requested from the server. In such a scenario, the complete sub resource information as extracted from the received main resource content becomes the additional sub resource information. Thereafter, the web page is displayed on the web browser on basis of the received main resource content and sub resource content corresponding to the sub resource information as extracted from the received main resource content.

However, if presence of additional sub resource information is not detected in the received main resource content in step 706, the web page is displayed, at step 710, on the web browser on the basis of the received main resource content and sub resource content. In an exemplary embodiment, the method 700 further includes storing the sub resource information and the additional sub resource information at a local location in mapped relationship with the parameter pertaining to the webpage.

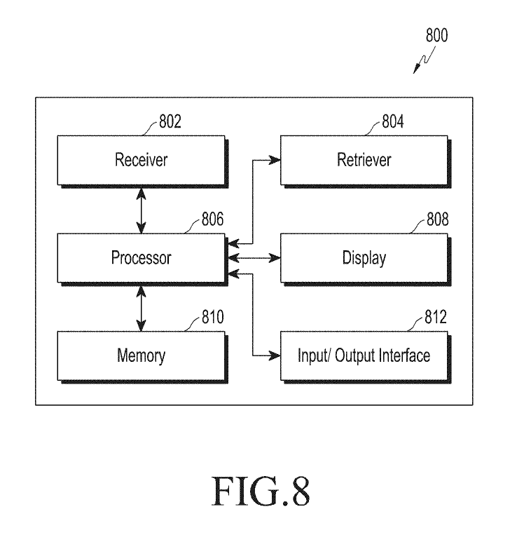

FIG. 8 is a block diagram of an electronic device 800 for displaying a webpage, according to another exemplary embodiment. The electronic device 800 includes a receiver 802 for receiving, on a web browser, a request to open a webpage, the webpage being associated with a main web Uniform Resource Locator (URL) and a retriever 804 for retrieving a sub resource information as pre-stored at a local location in mapped relationship with a parameter pertaining to the webpage and requesting for sub resource content associated with the sub resource information. A processor 806 is further provided for detecting presence of an additional sub resource information in received main resource content. In an exemplary embodiment, the processor 806 may control operations of other modules of the electronic device (i.e. the receiver 802, the memory 810, the retriever 804, the display 808, and the input/output interface 812 )

The electronic device 800 further includes a display 808 for displaying the web page on the web browser on basis of the received main resource content, sub resource content, and at least one additional sub resource content if presence of additional sub resource information is detected in the received main resource content, else displaying the web page on the web browser on basis of the received main resource content and at least one sub resource content. The electronic device 800 further includes memory 810 for storing the sub resource information. An input/output interface 812 is further provided for receiving one or more inputs from the user, for instance for receiving request to open a webpage. Each of the aforesaid modules/units is operably interconnected to each other.

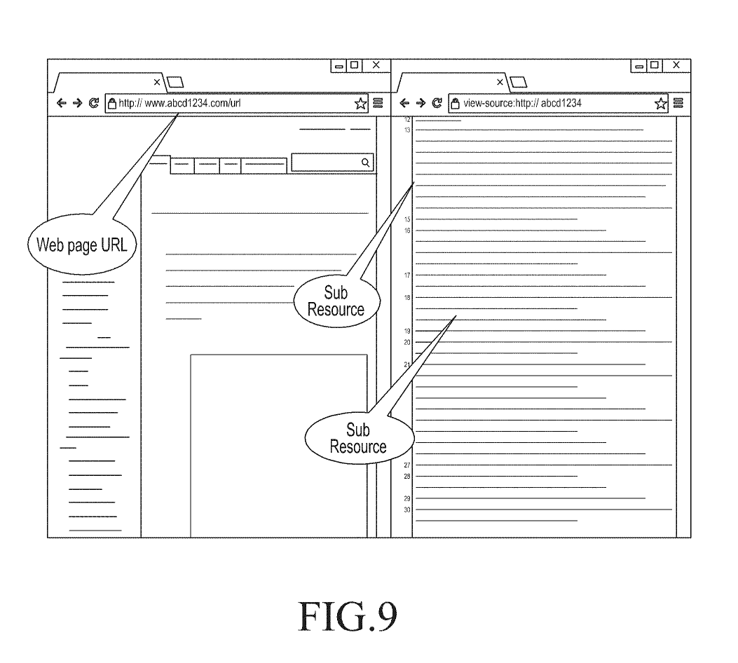

FIG. 9 shows a webpage according to an exemplary embodiment. The exemplary webpage as illustrated has the main web page URL www.abcd 1234. com/url. As discussed before, for loading the complete webpage, its main page resource (index.html) as well as sub resources (such as css, js/scripts, tiff, images, etc.) are to be fetched from the server. The sub resources corresponding to main web page URL are indicated in FIG. 9.

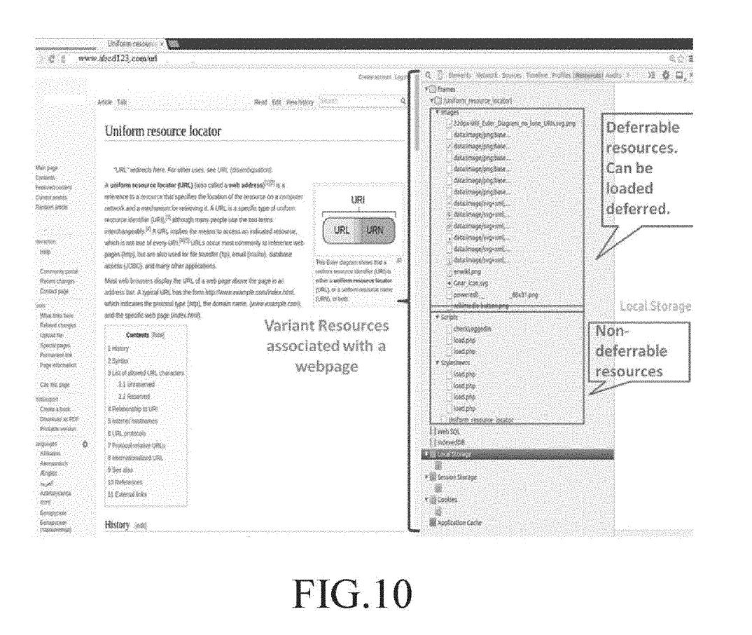

FIG. 10 shows another webpage indicating sub resources associated with a web url, according to an exemplary embodiment. The exemplary webpage indicates the deferrable and non-deferrable sub resources associated with the main web page URL www.abcd 123.com/tab.

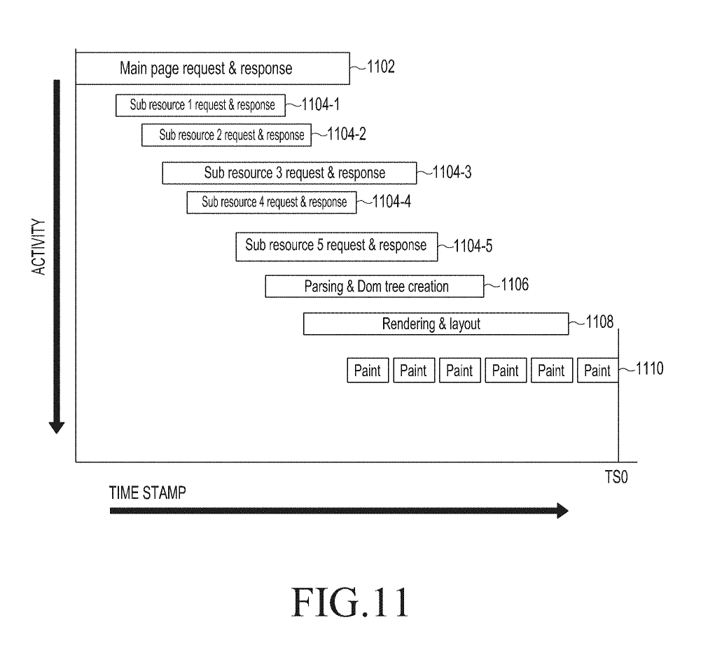

FIG. 11 is a diagram illustrating a flow of loading a webpage without using trained data. It can be seen that after a request for opening a web page is made from the client end, first the request for the main resource/page content is sent to the server and a response to the request is received from the server (block 1102 ). Once a chunk of data of main resource content is available at the client side, the client starts processing the main resource content and identifies the sub resources and associated information used to display the complete web page. In the present case, the sub resources namely Sub Resource 1, Sub Resource 2, Sub Resource 3, Sub Resource 4 and Sub Resource 5 were identified. Thus, it can be seen that the sub resources and associated information are identified only after the main resource content becomes available. A wait period is involved in receiving the main resource/page content from the server and thereafter identifying the sub resources and associated information and sending requests in respect of the identified sub resources. On identification of the sub resources and associated information, requests for these sub resources are sent to the server and responses thereto are received (blocks 1104-1, 1104-2, 1104-3, 1104-4, 1104-5 ). The subsequent chunk of content/data will be received at client side with respect to main resource and the sub resource and the client will keep processing the data. After processing the significant chunk of data, it starts parsing and creating the DOM (block 1106 ) and initiates the process of rendering and layout (block 1108 ). The next step of processing is to display/paint (block 1110 ) the main resource data/content and the data/content associated with the sub resources. The steps of parsing, rendering and painting can also be carried out in parallel to the request-response process for sub-resources. The total time stamp taken in processing and display of web page without trained information is taken as TSO for the purposes of explanation. A model data of the sub resources and associated information is also created and stored for future uses.

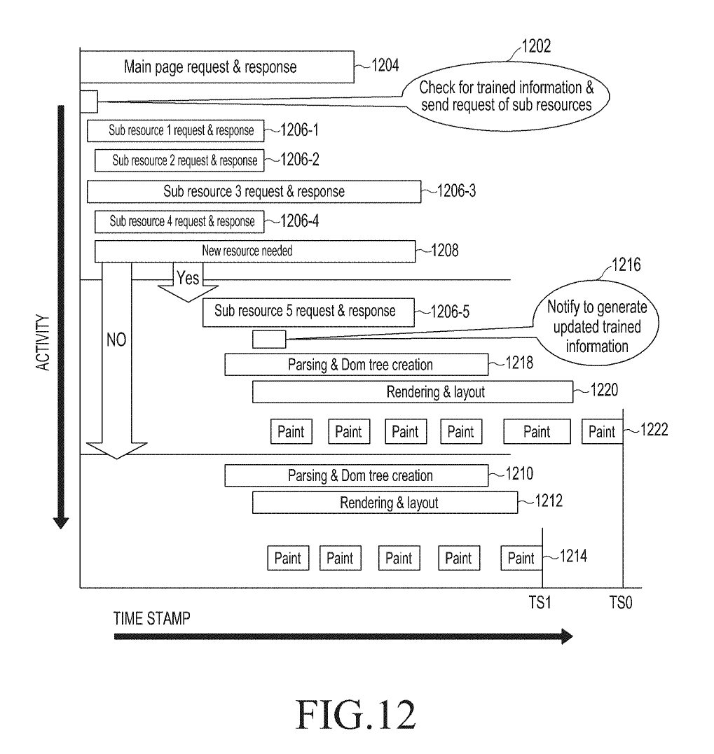

FIG. 12 is a diagram illustrating a flow of loading a webpage using trained data, according to an exemplary embodiment. In this case, the wait period as referred in FIG. 11 for receiving the main page/resource response from the server and thereafter identifying the sub resources and associated information and sending requests in respect of the sub resources is efficiently utilized. The requests in respect of the sub-resources are sent as soon as the client requests a main resource from the server, thereby utilizing the wait period. The requests for the retrieval of the main resource content and requests for the retrieval of the sub resource content may be made simultaneously; or the request for the retrieval of the main resource content may be made subsequent to making the request for the retrieval of the sub resource content; or the request for the retrieval of the main resource content is made prior to making the request for the retrieval of the sub resource content. While leveraging the aforesaid wait period, the exemplary embodiments utilize the trained information/data stored in the local memory of the client device.

Referring to FIG. 12, when a user requests for a webpage to load, it first checks for the availability of trained information/data about its sub-resources (1202) corresponding to the main web page requested. Assuming that the information pertaining to 4 sub resources namely Sub Resource 1, Sub Resource 2, Sub Resource 3, Sub Resource 4 is found, the client sends the requests (block (1206-1, 1206-2, 1206-3, 1206-4 ) for the aforesaid sub resources, as soon as the web page request is sent (block 1204 ). As the information in respect of the sub resources is already available, waiting of the main page response for identifying the sub resources is eliminated. Once the requests for main resource and sub resources content are sent, the chunk of data will be received at the client side with respect to main page/resource and the identified sub resources. Once the main resource content is received, the main resource content and the stored trained information are analyzed to detect presence of additional sub resource content in the received main resource content (block 1208 ). If presence of additional sub resource information is not detected, the system starts parsing and creating the DOM (block 1210 ) and initiates the process of rendering & layout (block 1212 ). The next step of processing is to display the received main resource content and the content associated with the identified sub resources. To display, the client uses the various paint requests (block 1214 ). The total time stamp taken in processing & display is taken as TS1 for the purposes of explanation.

On the other hand, if presence of an additional sub resource (for example Sub Resource 5 ) is detected, request for the Sub Resource 5 is sent (block 1206-5 ) while processing the remaining received content. Simultaneously, the stored trained information is also updated (block 1216 ). Thereafter, the system starts parsing and creating the DOM (block 1218) and initiates the process of rendering & layout (block 1220). The next step of processing is display the received main resource content and the content associated with the identified sub resources (namely Sub Resource 1, Sub Resource 2, Sub Resource 3, Sub Resource 4) and additional sub resource content pertaining to Sub Resource 5. To display, the client uses the various paint requests (block 1222). The total time stamp taken in processing and display is taken as TS 2 for the purposes of explanation.

From the above description of FIG.s 11 and 12, it can be noticed that the present proposed system enhances the performance of a web page & user experience in following relationship, i.e., TS<=TS2<=TS0. This indicates that if the trained information is present (partially or completely), it's likely to take less time to respond to a user request to load the complete webpage in comparison to when the trained information is not present at all.

The following data table illustrates the loading time of some example websites with and without implementing the exemplary embodiments trained data found as a result of experiments.

| | | Approx Load | Approx Load | Approximate |
|---|---|---|---|---|
| | | Time without | Time using | percentage |
| | Website | trained data | trained data | Gain in |
| NO | Description | (in seconds) | (in seconds) | Load Time |
| | Time Stamp | TS0 | TS2 | % = (1 − |
| | | | | TS2/TS0)*100 |
| | An Internet | 14 | 8 | 43% |
| | content service | | | |
| | provider website | | | |
| | An Information | 7 | 3 | 57% |
| | website | | | |
| | A Social | 8 | 5 | 37% |
| | Networking | | | |
| | website | | | |
| | A Web | 5 | 3 | 40% |
| | Application | | | |
| | Development | | | |
| | website | | | |

From the above table, it can be noticed that significant gain in load time is achieved when the is the exemplary embodiments are implemented. However, it may be strictly understood that the above findings have been found as a result of experiments and shall not be construed as being limitations towards the exemplary embodiments.

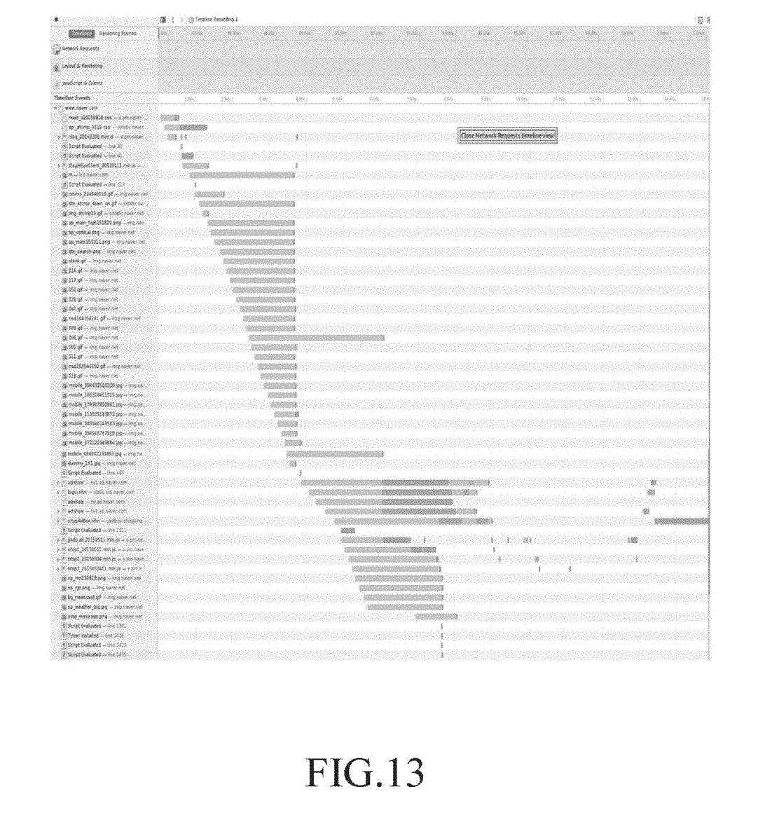

FIG. 13 is a timing diagram of loading of an internet content service website, using a web inspector. The loading time of the web page in such a case was found to be 14 seconds.

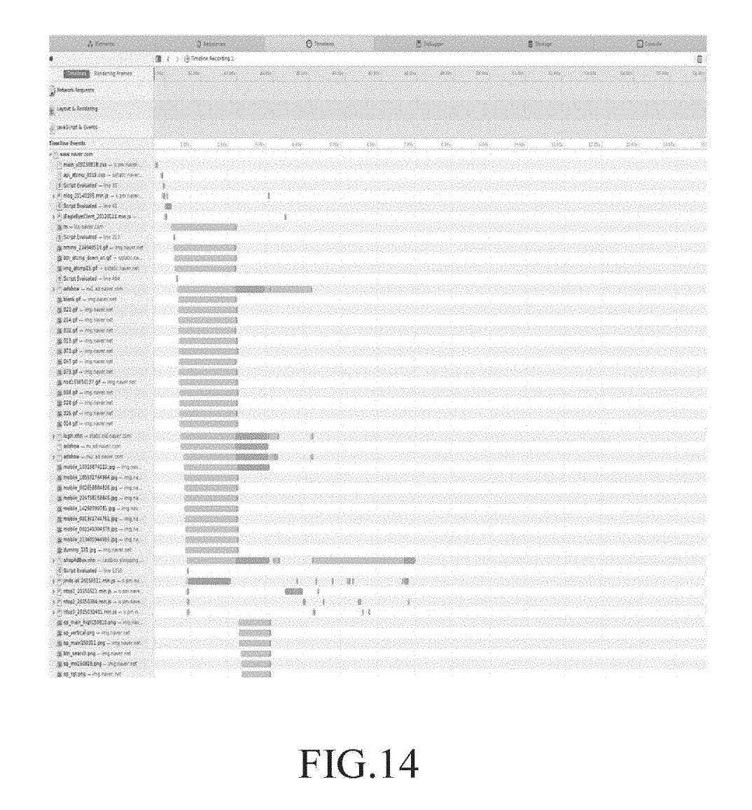

FIG. 14 is a timing diagram of loading of an internet content service website, using a web inspector according to an exemplary embodiment. The loading time of the web page in such a case was found to be 8 seconds. It can be noticed that significant gain in load time (approximately 43 percent) is achieved when the exemplary embodiments are implemented.

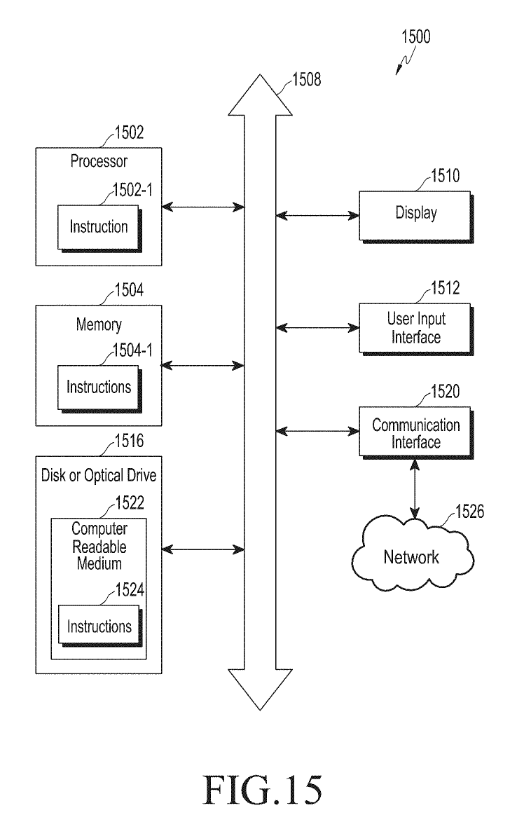

FIG. 15 is a diagram illustrating a hardware configuration of a computer system representative of a hardware environment, according to an exemplary embodiment. A hardware configuration of the system 300, 700 in the form of a computer system 1500 is shown. The computer system 1500 can include a set of instructions that can be executed to cause the computer system 1500 to perform any one or more of the methods disclosed. The computer system 1500 may operate as a standalone device or may be connected, e.g., using a network, to other computer systems or peripheral devices.

In a networked deployment, the computer system 1500 may operate in the capacity of a server or as a client user computer in a server-client user network environment, or as a peer computer system in a peer-to-peer (or distributed) network environment. The computer system 1500 can also be implemented as or incorporated into various devices, such as a personal computer (PC), a tablet PC, a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. Further, while a single computer system 1500 is illustrated, the term “system” shall also be taken to include any collection of systems or sub-systems that individually or jointly execute a set, or multiple sets, of instructions to perform one or more computer functions.

The computer system 1500 may include a processor 1502, e.g., a central processor (CPU), a graphics processor (GPU), or both, which is configured to process an instruction 1502-1. The processor 1502 may be a component in a variety of systems. For example, the processor may be part of a standard personal computer or a workstation. The processor 1502 may be one or more general processors, digital signal processors, application specific integrated circuits, field programmable gate arrays, servers, networks, digital circuits, analog circuits, combinations thereof, or other now known or later developed devices for analyzing and processing data. The processor 1502 may implement a software program, such as code generated manually (i.e., programmed).

The computer system 1500 may include a memory 1504, such as a memory 1504 that can communicate via a bus 1508. The memory 1504 may be a main memory, a static memory, or a dynamic memory. The memory 1504 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory 1504 includes a cache or random access memory for the processor 1502. In alternative examples, the memory 1504 is separate from the processor 1502, such as a cache memory of a processor, the system memory, or other memory. The memory 1504 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1504 is operable to store instructions 1504-1 executable by the processor 1502. The functions, acts or tasks illustrated in the figures or described may be performed by the programmed processor 1502 executing the instructions 1504-1 stored in the memory 1504. The functions, acts or tasks are independent of the type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 1500 may or may not further include a display 1510, such as a liquid crystal display (LCD), an organic light emitting diode (OLED), a flat panel display, a solid state display, a cathode ray tube (CRT), a projector, a printer or other now known or later developed display device for outputting determined information. The display 1510 may act as an interface for the user to see the functioning of the processor 1502, or as an interface with the software stored in the memory 1504 or in a disk or optical drive 1516.

Additionally, the computer system 1500 may include a user input interface 1512 configured to allow a user to interact with any of the components of system 1500. The user input interface 1512 may be a number pad, a keyboard, or a cursor control device, such as a mouse, or a joystick, touch screen display, remote control or any other device operative to interact with the computer system 1500.

The computer system 1500 may also include the disk or optical drive 1516. The disk or optical device 1516 may include a computer-readable medium 1522 in which one or more sets of instructions 1524, e.g., software, can be embedded. Further, the instructions 1524 may embody one or more of the methods or logic as described. In an example, the instructions 1524 may reside completely, or at least partially, within the memory 1504 or within the processor 1502 during execution by the computer system 1500. The memory 1504 and the processor 1502 also may include computer-readable media as discussed above.

The exemplary embodiments contemplate a computer-readable medium that includes instructions 1524 or receives and executes instructions 1524 responsive to a propagated signal so that a device connected to a network 1526 can communicate voice, video, audio, images or any other data over the network 1526. Further, the instructions 1524 may be transmitted or received over the network 1526 via a communication port or interface 1520 or using a bus 1508. The communication port or interface 1520 may be a part of the processor 1502 or may be a separate component. The communication port 1520 may be created in software or may be a physical connection in hardware. The communication port 1520 may be configured to connect with a network 1526, external media, the display 1510, or any other components in system 1500 or combinations thereof. The connection with the network 1526 may be a physical connection, such as a wired Ethernet connection or may be established wirelessly as discussed later Likewise, the additional connections with other components of the system 1500 may be physical connections or may be established wirelessly. The network 1526 may alternatively be directly connected to the bus 1508.

The network 1526 may include wired networks, wireless networks, Ethernet AVB networks, or combinations thereof. The wireless network may be a cellular telephone network, an 802.11, 802.16, 802.20, 802.1 Q or WiMax network. Further, the network 1526 may be a public network, such as the Internet, a private network, such as an intranet, or combinations thereof, and may utilize a variety of networking protocols now available or later developed including, but not limited to TCP/IP based networking protocols.

In an alternative example, dedicated hardware implementations, such as application specific integrated circuits, programmable logic arrays and other hardware devices, can be constructed to implement various parts of the system 1500.

In addition, the exemplary embodiments may also be implemented through computer-readable code and/or instructions on a medium, e.g., a computer-readable medium, to control at least one processing element to implement any above-described embodiments. The medium may correspond to any medium or media that may serve as a storage and/or perform transmission of the computer-readable code.

The computer-readable code may be recorded and/or transferred on a medium in a variety of ways, and examples of the medium include recording media, such as magnetic storage media (e.g., ROM, floppy disks, hard disks, etc.) and optical recording media (e.g., compact disc read only memories (CD-ROMs) or digital versatile discs (DVDs)), and transmission media such as Internet transmission media. Thus, the medium may have a structure suitable for storing or carrying a signal or information, such as a device carrying a bitstream according to one or more exemplary embodiments. The medium may also be on a distributed network, so that the computer-readable code is stored and/or transferred on the medium and executed in a distributed fashion. Furthermore, the processing element may include a processor or a computer processor, and the processing element may be distributed and/or included in a single device.

The foregoing exemplary embodiments are examples and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method of displaying a webpage, the method comprising:
receiving, via a web browser, a request to open the webpage corresponding to a main web Uniform Resource Locator (URL);
retrieving sub resource information that is pre-stored at a local location that is mapped to a parameter of the requested webpage;
requesting for sub resource content, based on the retrieved sub resource information;
receiving the requested sub resource content; and
displaying the web page on the web browser, based on the received sub resource content and a main resource content.

2. The method as claimed in claim 1, further comprising:
receiving the main resource content;
detecting additional sub resource information in the received main resource content; and
requesting for additional sub resource content, based on the detected additional sub resource information.

3. The method as claimed in claim 2, further comprising extracting the additional sub resource information from the received main resource content.

4. The method as claimed in claim 2, further comprising:
receiving the requested additional sub resource content; and
displaying the web page on the web browser, based on the received main resource content, the received sub resource content, and the received additional sub resource content.

5. The method as claimed in claim 1, further comprising:
requesting for the main resource content; and
receiving the requested main resource content.

6. The method as claimed in claim 5, wherein:
the requesting for the main resource content and the requesting for the sub resource content are performed simultaneously; or
the requesting for the main resource content is performed subsequent to the requesting for the sub resource content; or
the requesting for the main resource content is performed prior to the requesting for the sub resource content.

7. The method as claimed in claim 1, wherein the retrieving of the sub resource information is based on any one or any combination of:
a priority value of the sub resource information;
a time of load information;
a level of independency of the sub resource information; and
a type of the sub resource content corresponding to the sub resource information.

8. The method as claimed in claim 7, further comprising storing the sub resource information at the local location.

9. The method as claimed in claim 1, further comprising:
accessing the main web URL prior to the receiving of the request to open the webpage; and
generating and storing the sub resource information at the local location.

10. The method as claimed in claim 9, wherein the generating and storing of the sub resource information comprises:
retrieving, from a server, the main resource content corresponding to the main web URL;
parsing the retrieved main source content to identify one or more sub-resources; and
generating and storing model data, based on the identified one or more sub-resources.

11. The method as claimed in claim 1, further comprising:
receiving the main resource content;
processing the received main resource content to extract sub resource information from the received main resource content;
analyzing the extracted sub resource information with the pre-stored sub resource information; and
updating the pre-stored sub resource information, based on the analyzing.

12. The method as claimed in claim 11, wherein the updating comprises any one or any combination of a modification, an insertion, or a deletion that is made to a part of the pre-stored sub resource information.

13. The method as claimed in claim 1, further comprising updating the pre-stored sub resource information, based on any one or any combination of:
a priority value of the pre-stored sub resource information;
a time of load information; and
meta data of a sub resource.

14. The method as claimed in claim 1, wherein the sub resource information comprises information of one or more sub resources comprising any one or any combination of:
images;
video files;
audio files;
scripts;
style sheets web fonts; and
a sub resource to be used for displaying or rendering the sub resource or another sub resource.

15. The method as claimed in claim 1, wherein the request to open the webpage comprises:
an individual request for an URL; or
a list of one or more URLs that are requested together; or
a list of one or more URLs that are requested in a batch mode.

16. A method of displaying a webpage, the method comprising:
receiving, via a web browser, a request to open the webpage corresponding to a main web Uniform Resource Locator (URL);
retrieving a sub resource information that is pre-stored at a local location that is mapped to a parameter of the requested webpage;
requesting for sub resource content, based on the retrieved sub resource information;
receiving main resource content and the requested sub resource content;
determining whether additional sub resource information is in the received main resource content;
displaying the web page on the web browser, based on the received main resource content, the received sub resource content, and the additional sub resource content, in response to the determining that the additional sub resource content is in the received main resource content; and
displaying the web page on the web browser, based on the received main resource content and the received sub resource content, in response to the determining that the additional sub resource content is not in the received main resource content.

17. The method as claimed in claim 16, further comprising:
extracting sub resource information from the received main resource content; and
comparing the extracted sub resource information with the pre-stored sub resource information.

18. The method as claimed in claim 16, further comprising storing the sub resource information and the additional sub resource information at the local location.

19. An electronic device for displaying a webpage, the electronic device comprising:
a first receiver configured to receive, via a web browser, a request to open the webpage corresponding to a main web Uniform Resource Locator (URL);
a retriever configured to:
retrieve sub resource information that is pre-stored at a local location that is mapped to a parameter of the requested webpage; and
request for sub resource content, based on the retrieved sub resource information;
a second receiver configured to receive the requested sub resource content; and
a display configured to display the web page on the web browser, based on the received sub resource content and a main resource content.

20. An electronic device for displaying a webpage, the electronic device comprising:
a receiver configured to receive, via a web browser, a request to open the webpage corresponding to a main web Uniform Resource Locator (URL);
a retriever configured to:
retrieve a sub resource information that is pre-stored at a local location that is mapped to a parameter of the requested webpage; and
request for sub resource content, based on the retrieved sub resource information,
wherein the receiver is further configured to receive main resource content and the requested sub resource content;
a processor configured to determine whether additional sub resource information is in the received main resource content; and
a display configured to:
display the web page on the web browser, based on the received main resource content, the received sub resource content, and the additional sub resource content, in response to the determining that the additional sub resource content is in the received main resource content; and
display the web page on the web browser, based on the received main resource content and the received sub resource content, in in response to the determining that the additional sub resource content is not in the received main resource content.
